(19) United States
(12) Patent Application Publication
(10) Pub. No.: US 2025/0045401 A1
(43) Pub. Date: Feb. 6, 2025

(54) EXTEND MACHINE TRUST TO THIRD-PARTY FIRMWARE

(71) Applicant: Dell Products L.P., Round Rock, TX (US)

(72) Inventors: Joshua M. PENNELL, Walla Walla, WA (US); Divya VIJAYVARGIYA, Cedar Park, TX (US); Aniruddha Suresh HEREKAR, Leander, TX (US)

(73) Assignee: Dell Products L.P., Round Rock, TX (US)

(21) Appl. No.: 18/364,067

(22) Filed: Aug. 2, 2023

(51) Int. Cl. G06F 21/57; G06F 21/33; G06F 21/60

(52) U.S. Cl. CPC G06F 21/572; G06F 21/33; G06F 21/602

(57) ABSTRACT

An information handling system may include a host system; and a management controller comprising a firmware that includes a bootloader component that is cryptographically signed by a manufacturer of the information handling system and a runtime component that is not cryptographically signed by the manufacturer of the information handling system. The management controller may be configured to establish trust with a remote information handling system by: receiving a handshake request from the remote information handling system, the handshake request including a payload; encrypting the payload via a key that is accessible by the bootloader component but not accessible by the runtime component; and responding to the handshake request by transmitting the encrypted payload to the remote information handling system.

### TECHNICAL FIELD

The present disclosure relates in general to information handling systems, and more particularly to techniques for establishing trust with management controllers of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems include management controllers for providing out-of-band management. In various embodiments, management controllers may perform low-level tasks such as measuring temperature probes and managing fan speeds, to more medium level-tasks such as providing a way to change BIOS settings, up through higher-level functions such as acting as “virtual media” for the system to allow for installing an operating system, etc. Some information handling systems may include multiple management controllers, such as one or more baseboard management controllers (BMCs) for individual modular servers (e.g., blades) of a server chassis, plus an enclosure controller or a chassis management controller for the system as a whole.

Historically, management controller firmware has typically been implemented as a firmware image that is developed by the manufacturer, cryptographically signed, and loaded onto the management controller. However, with the advent of open-source management controller code (e.g., OpenBMC, a Linux distribution for management controllers) there is a growing need to support a customer's ability to run a DIY management controller firmware stack. For example, a customer may build a DIY management controller firmware by integrating a manufacturer's bootloader and other manufacturer components with a more generic firmware runtime such as OpenBMC. Typically these manufacturer components are provided as precompiled binaries and integrated into the DIY firmware image by the customer.

The use of DIY firmware raises issues with security, however.

When a manufacturer's own management controller firmware is running, it generally provides security guarantees from the hardware root of trust all the way up to the application level. This root of trust enables the chassis (e.g., the chassis management controller) to establish secure communications among all of the devices within the chassis.

One important part of establishing trust is the “proof of possession” stage in which a BMC must prove that it is an authentic device from the correct manufacturer. This is done by receiving a challenge request from the chassis management controller and encrypting it with the correct key. The BMC returns the encrypted response to the chassis management controller, which verifies that it was encrypted by an authentic manufacturer ID certificate.

For example, when a modular server blade that includes a BMC running a manufacturer's firmware is added to a chassis, trust may be established between the chassis management controller and the BMC via an encrypted challenge-response that verifies that the BMC has access to the manufacturer's ID certificate/hidden root key (HRK). The HRK may be implemented as an AES key that is embedded in the silicon of the BMC in such a way that it cannot be manually read out, but is used internally for encryption and decryption of user data, certificates, etc.

However, if a modular server blade including a BMC running a customer's DIY firmware stack is added to a chassis, there is currently no mechanism available to certify the hardware ID of the server to integrate it into the hardware root of trust. This is because the customer's DIY firmware would not have access to the manufacturer's hardware ID certificates, because the manufacturer bootloader may disable access to the HRK when booting the DIY firmware, because it is not signed by the manufacturer. This prevents the DIY firmware from accessing the HRK or hardware ID certificates.

This can create issues, because the modular server must establish trust with the chassis to be able to request power and network capabilities. Without establishing trust, the server may receive only auxiliary (AUX) power, sufficient for running the BMC, but insufficient for running the host system. This may result in the chassis management controller being unable to communicate with the inserted blade.

Embodiments may provide improvements in the field of establishing trust with information handling systems in which a management controller is provisioned with a third-party firmware instead of the manufacturer's own firmware.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with third-party firmware in management controllers of information handling systems may be reduced or eliminated.

In accordance with embodiments of the present disclosure, an information handling system may include a host system; and a management controller comprising a firmware that includes a bootloader component that is cryptographically signed by a manufacturer of the information handling system and a runtime component that is not cryptographically signed by the manufacturer of the information handling system. The management controller may be configured to establish trust with a remote information handling system by: receiving a handshake request from the remote information handling system, the handshake request including a payload; encrypting the payload via a key that is accessible by the bootloader component but not accessible by the runtime component; and responding to the handshake request by transmitting the encrypted payload to the remote information handling system.

In accordance with these and other embodiments of the present disclosure, a method may include a management controller of an information handling system receiving handshake request from a remote information handling system, the handshake request including a payload, wherein the management controller includes a firmware that includes a bootloader component that is cryptographically signed by a manufacturer of the information handling system and a runtime component that is not cryptographically signed by the manufacturer of the information handling system; the management controller encrypting the payload via a key that is accessible by the bootloader component but not accessible by the runtime component; and the management controller responding to the handshake request by transmitting the encrypted payload to the remote information handling system.

In accordance with these and other embodiments of the present disclosure, an article of manufacture may include a non-transitory, computer-readable medium having computer-executable instructions thereon that are executable by a processor of a management controller of an information handling system, wherein the management controller includes a firmware that includes a bootloader component that is cryptographically signed by a manufacturer of the information handling system and a runtime component that is not cryptographically signed by the manufacturer of the information handling system, the instructions executable for: receiving handshake request from a remote information handling system, the handshake request including a payload; encrypting the payload via a key that is accessible by the bootloader component but not accessible by the runtime component; and responding to the handshake request by transmitting the encrypted payload to the remote information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a sequence diagram of an example method, in accordance with a first embodiment of the present disclosure; and

FIG. 3 illustrates a sequence diagram of an example method, in accordance with a second embodiment of the present disclosure.

### DETAILED DESCRIPTION

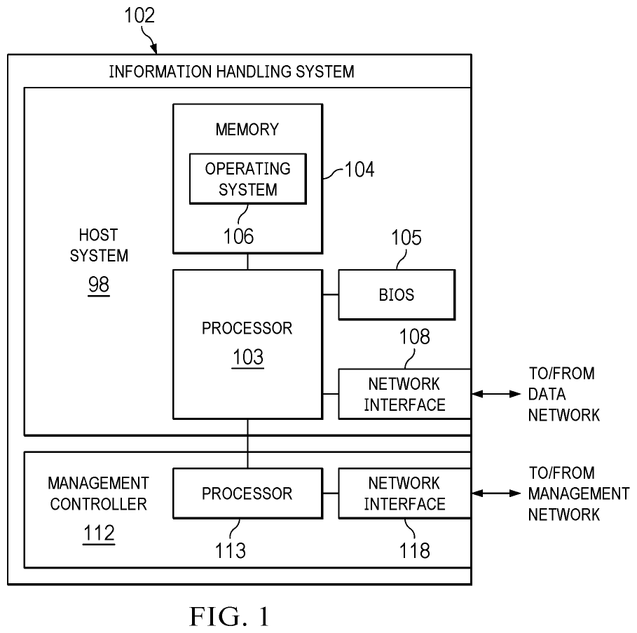

Preferred embodiments and their advantages are best understood by reference to FIGS. 1-3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic storage device, or any other suitable device, a network device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, or device operable to serve as an interface apparatus, between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the ability to run software or firmware on a BMC such as management controller 112 that has not been digitally signed by the manufacturer thereof. For example, a DIY firmware package may run on the BMC that may include some components signed by the manufacturer (e.g., a bootloader and/or other components) and some components not signed by the manufacturer. This disclosure broadly provides two methods for establishing trust between a chassis and a newly inserted information handling system that includes such a BMC.

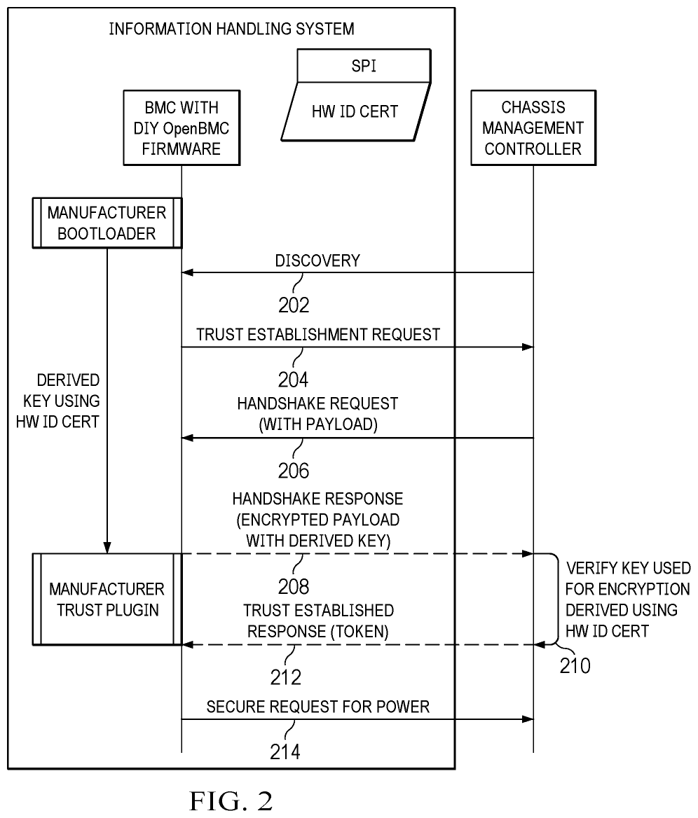

According to a first embodiment as shown in FIG. 2, a trust model may be implemented via a trust plugin that extends the machine trust to third-party firmware running on the manufacturer's hardware. In this implementation, a manufacturer-signed bootloader is used with the customer's DIY BMC firmware. Even though the HRK itself may be unavailable in the situation of an unsigned DIY firmware, the manufacturer-signed bootloader may create a derived certificate based on the hardware ID certificate (which may be located on a storage medium such as a serial peripheral interface (SPI) flash device).

A customer building their own DIY firmware may also include a manufacturer-provided trust plugin, which may be configured to read the derived certificate created by the bootloader and encrypt handshake data for use in communicating with the chassis management controller. The chassis management controller may then verify that the derived public key is authentic and derived from the manufacturer-installed hardware ID certificate. This may ensure that the third-party firmware is running on authentic system provided by that manufacturer.

In some embodiments, whenever the BMC of the inserted information handling system is reset, trust may need to be re-established by the chassis before it responds to the blade's request for power, networking, etc. This is to ensure that a blade previously inserted into the chassis and trusted via the manufacturer's signed firmware is not able to bypass establishing trust later after having been updated to a DIY firmware.

Turning now to FIG. 2, an example sequence diagram is shown of a method for implementing the first embodiment described above. In this embodiment, an information handling system has been inserted into a chassis that includes a management controller such a as chassis management controller or an enclosure controller. The information handling system includes a host system (not shown), a BMC provisioned with a customer's DIY OpenBMC firmware (which includes the manufacturer bootloader and the manufacturer trust plugin), and a SPI storage resource including a hardware ID certificate for the information handling system.

At step 202, the chassis management controller may discover the inserted information handling system. At step 204, the BMC may seek to establish trust with the chassis.

Meanwhile, the manufacturer bootloader may prepare a derived key based on the hardware ID certificate stored in the SPI storage resource. This may be transmitted to the manufacturer trust plugin.

At step 206, the chassis management controller may transmit a handshake request with a payload (e.g., a nonce or some other data). The BMC may then encrypt the payload with the derived key and use this to respond to the handshake request at step 208.

The chassis management controller may verify the encrypted payload and establish trust at steps 210-212. Once trust is established, the BMC may request power, and the host system of the information handling system may power on.

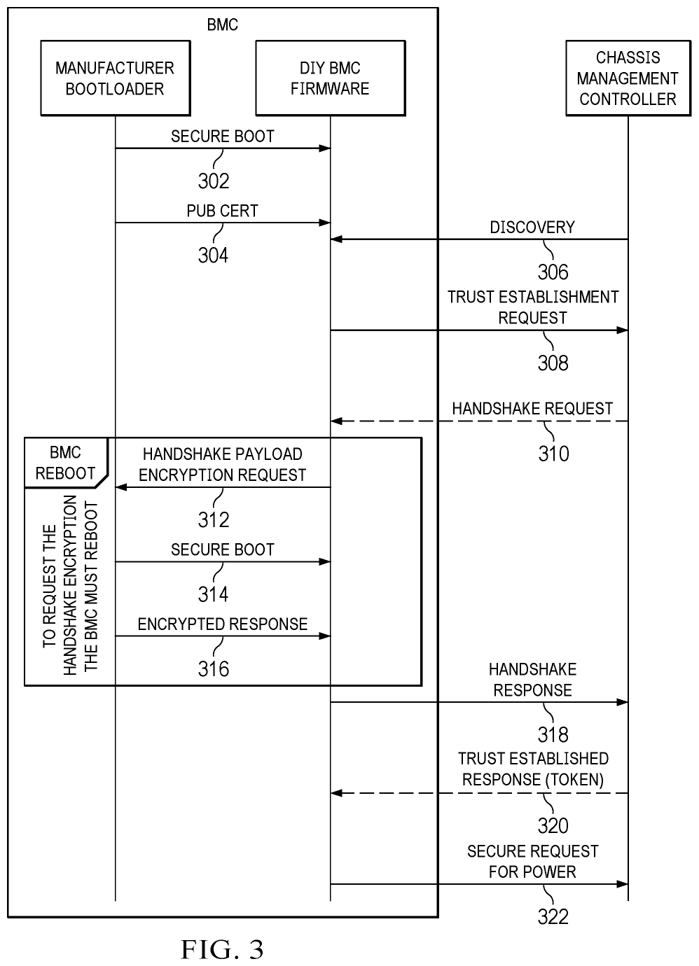

According to a second embodiment as shown in FIG. 3, hardware ID certificates from SPI flash are once again used to establish trust between the third-party firmware and the chassis management controller. In this embodiment, the manufacturer bootloader may pass the hardware ID public key (obtained from the hardware ID certificates) to the third-party firmware and request an encrypted handshake.

Once the BMC is booted to the third-party firmware (using secure boot), it may encrypt the data requested using the hardware ID public key and reset itself. The manufacturer bootloader may decrypt the data using the hardware ID private key to confirm that it is the same data that was sent to the BMC for encryption. This solution requires a BMC reboot, and the second BMC boot will be allowed only if the trust handshake was successful between the manufacturer bootloader and the third-party firmware.

Turning now to FIG. 3, an example sequence diagram is shown of a method for implementing the second embodiment described above. In this embodiment as well, an information handling system has been inserted into a chassis that includes a management controller such as a chassis management controller or an enclosure controller. For the sake of brevity and clarity, FIG. 3 shows only the BMC of the information handling system and the chassis management controller of the chassis. The BMC has been provisioned with a the manufacturer's bootloader and the customer's DIY firmware.

At step 302, the manufacturer bootloader performs a secure boot to begin execution of the DIY firmware, and at step 304 it passes the hardware ID public key to the DIY firmware.

At steps 306-310 (similar to the corresponding steps from FIG. 2 discussed above), the chassis management controller and the DIY firmware communicate with one another to begin a handshake to establish trust.

In this case, however, the DIY firmware passes the payload to the manufacturer bootloader for encryption at step 312, and the BMC reboots. Upon this subsequent boot, the bootloader encrypts the payload (e.g., with the HRK, which the bootloader can access, but which the DIY firmware cannot access). The bootloader then once again performs a secure boot to begin execution of the DIY firmware, and at step 316 it passes the encrypted response back to the DIY firmware.

Steps 318-322 (similar to the corresponding steps from FIG. 2 discussed above) complete the trust establishment procedure, with the DIY firmware using the encrypted payload in its handshake response to the chassis management controller.

One of ordinary skill in the art with the benefit of understand that the preferred this disclosure will initialization points for the methods depicted in FIGS. 2-3 and the order of the steps comprising the methods may depend on the implementations chosen. In these and other embodiments, the methods may be implemented as hardware, firmware, software, applications, functions, libraries, or other instructions. Further, although FIGS. 2-3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various substitutions, changes, and alterations could be made hereto without departing from the spirit and scope of the disclosure.

What is claimed is:

1. An information handling system comprising:
a host system; and
a management controller comprising a firmware that includes a bootloader component that is cryptographically signed by a manufacturer of the information handling system and a runtime component that is not cryptographically signed by the manufacturer of the information handling system;
wherein the management controller is configured to establish trust with a remote information handling system by:
receiving a handshake request from the remote information handling system, the handshake request including a payload;
encrypting the payload via a key that is accessible by the bootloader component but not accessible by the runtime component; and
responding to the handshake request by transmitting the encrypted payload to the remote information handling system.

2. The information handling system of claim 1, wherein the remote information handling system is a chassis management controller.

3. The information handling system of claim 1, wherein the management controller comprises a baseboard management controller (BMC).

4. The information handling system of claim 1, wherein the key is a derived key based on a hardware identity certificate.

5. The information handling system of claim 1, wherein the key is a hidden root key (HRK).

6. The information handling system of claim 5, wherein the runtime component is configured to transmit the payload to the bootloader component for encryption, and wherein the bootloader component is configured to encrypt the payload upon a subsequent boot of the management controller.

7. A method comprising:
a management controller of an information handling system receiving handshake request from a remote information handling system, the handshake request including a payload, wherein the management controller includes a firmware that includes a bootloader component that is cryptographically signed by a manufacturer of the information handling system and a runtime component that is not cryptographically signed by the manufacturer of the information handling system;
the management controller encrypting the payload via a key that is accessible by the bootloader component but not accessible by the runtime component; and
the management controller responding to the handshake request by transmitting the encrypted payload to the remote information handling system.

8. The method of claim 7, wherein the remote information handling system is a chassis management controller.

9. The method of claim 7, wherein the management controller comprises a baseboard management controller (BMC).

10. The method of claim 7, wherein the key is a derived key based on a hardware identity certificate.

11. The method of claim 7, wherein the key is a hidden root key (HRK).

12. The method of claim 11, wherein the runtime component is configured to transmit the payload to the bootloader component for encryption, and wherein the bootloader component is configured to encrypt the payload upon a subsequent boot of the management controller.

13. An article of manufacture comprising a non-transitory, computer-readable medium having computer-executable instructions thereon that are executable by a processor of a management controller of an information handling system, wherein the management controller includes a firmware that includes a bootloader component that is cryptographically signed by a manufacturer of the information handling system and a runtime component that is not cryptographically signed by the manufacturer of the information handling system, the instructions executable for:
receiving handshake request from a remote information handling system, the handshake request including a payload;
encrypting the payload via a key that is accessible by the bootloader component but not accessible by the runtime component; and
responding to the handshake request by transmitting the encrypted payload to the remote information handling system.

14. The article of claim 13, wherein the remote information handling system is a chassis management controller.

15. The article of claim 13, wherein the management controller comprises a baseboard management controller (BMC).

16. The article of claim 13, wherein the key is a derived key based on a hardware identity certificate.

17. The article of claim 13, wherein the key is a hidden root key (HRK).

18. The article of claim 17, wherein the runtime component is configured to transmit the payload to the bootloader component for encryption, and wherein the bootloader component is configured to encrypt the payload upon a subsequent boot of the management controller.
